(19) United States
(12) Patent Application Publication
(10) Pub. No.: US 2012/0045293 A1
(43) Pub. Date: Feb. 23, 2012

(54) REPLACEABLE THREAD LOCKING ELEMENT

(75) Inventors: James K. Baxter, St. Paul, MN (US); Michael A. Krsiean, Houlton, WI (US); Dale J. Hagenson, East Bethel, MN (US)

(73) Assignee: HONEYWELL INTERNATIONAL INC., Morristown, NJ (US)

(21) Appl. No.: 12/859,831

(22) Filed: Aug. 20, 2010

(51) Int. Cl. F16B 39/24; B23P 11/00

(52) U.S. Cl. 411/511; 29/525.11

(57) ABSTRACT

Systems and methods for replaceable thread locking elements are provided. In one embodiment, a threaded fastener device comprises: a first member having a threaded region; a cutout within the ring shaped member that cuts across the threaded region; and a replaceable thread locking element removeably coupled to the ring shaped member within the cutout, the replaceable thread locking element comprising a displacement member coupled to a nipple via an extending member. The nipple is inserted into and orifice within the cutout, the nipple shaped to apply a force against the first member that holds the displacement member within the cutout.

### BACKGROUND

In the assembly of many different types of devices, threaded fasteners are often torqued to achieve a desired tightness or pre-load. Such torqueing is performed to ensure that the components being fastened together are sufficiently held together to withstand the particular conditions and environment to which they will be exposed when used. In most situations the tightening is sufficient to keep the fasteners torque to the pre-load levels until such time as the device is disassembled for maintenance or repair. In some applications, however, the threaded fasteners are exposed to situations such as thermal cycling or vibration where the threaded joint can loosen and loose the tightening pre-load torque that was initially applied. Such loss of pre-load can cause failure of a joint or loss of fastener. To address such applications, thread locking elements or compounds are used on the threads of the fasteners. The problem with thread locking elements as they exist are known in the world today is that they are permanently applied. As a result, when the assembled devices need to be disassembled, fasteners with the thread locking element must be replaced entirely. Otherwise, if they are re-used, there is a risk that the thread locking element will fail to secure the fastened at the pre-load because they will lose effectiveness after repeated installation and removal.

For the reasons stated above and for other reasons stated below which will become apparent to those skilled in the art upon reading and understanding the specification, there is a need in the art for improved thread locking elements.

### SUMMARY

The Embodiments of the present invention provide methods and systems for improved thread locking elements and will be understood by reading and studying the following specification.

In one embodiment, a threaded fastener device comprises: a first member having a threaded region; a cutout within the ring shaped member that cuts across the threaded region; and a replaceable thread locking element removeably coupled to the ring shaped member within the cutout, the replaceable thread locking element comprising a displacement member coupled to a nipple via an extending member. The nipple is inserted into and orifice within the cutout, the nipple shaped to apply a force against the first member that holds the displacement member within the cutout.

### DRAWINGS

Embodiments of the present invention can be more easily understood and further advantages and uses thereof more readily apparent, when considered in view of the description of the preferred embodiments and the following figures in which:

FIGS. 1-3 are diagrams illustrating a male threaded ring fastener of one embodiment of the present invention;

FIG. 4 is a diagram illustrating a replaceable thread locking element of one embodiment of the present invention;

FIG. 5 is a diagram providing a cross-sectional view of a replaceable thread locking element inserted within a threaded fastener of one embodiment of the present invention;

FIG. 6 is a diagram illustrating a male threaded fastener of one embodiment of the present invention;

FIG. 7 is a diagram illustrating a female threaded ring fastener of one embodiment of the present invention; and

FIG. 8 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide the ability to effectively re-use threaded fasteners by providing said fasteners with replaceable thread locking elements. As will be described in greater detail below, the replaceable thread locking elements provided by embodiments of the present invention are easily removed from a threaded fastener and replaced with a new thread locking element prior to re-fastening and torqueing.

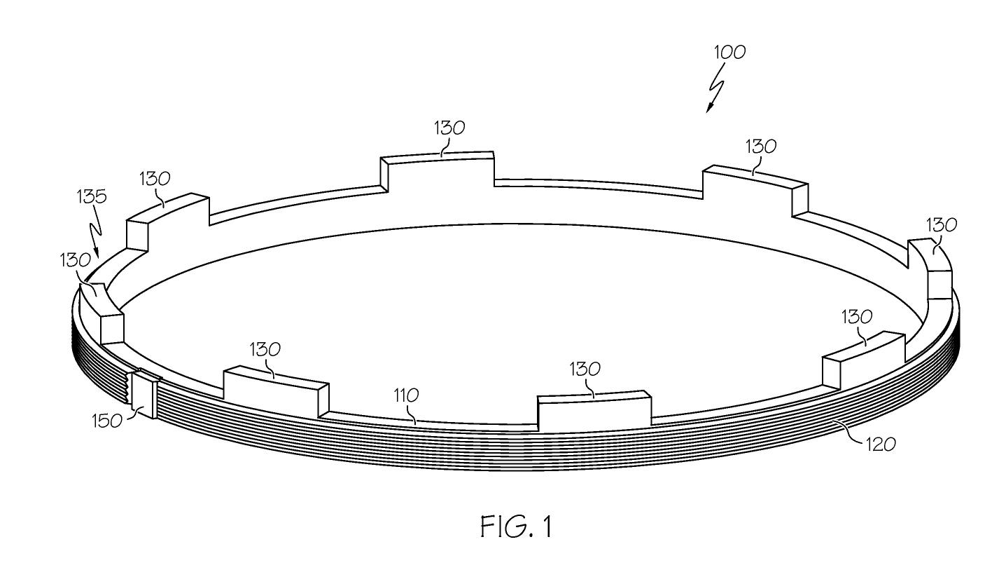

FIG. 1 is a diagram illustrating a threaded ring fastener 100 of one embodiment of the present invention. Threaded ring fastener 100 comprises a ring shaped member 110 having a threaded region 120 about its outer circumference. Ring shaped member 110 further includes a plurality of teeth 130 which define a tool engagement interface 135 that allows a torque wrench or other tool adapted with a corresponding interface to apply torque to threaded ring fastener 100. One of ordinary skill in the art would appreciate that in various alternate embodiments, the particular shapes used to define the tool engagement interface will vary based on the application where fastener 100 is to be used, and the amount of pre-load torque to be applied on the fastener 100 by the tool. Accordingly, the particular tooth shaped interface 135 illustrated in FIG. 1 is not intended to limit embodiments of the present invention to only the shape shown.

As shown in greater detail in FIGS. 2 and 3, ring shaped member 110 includes a cutout 140 that cuts across threaded region 120. Cutout 140 includes an orifice 145, which in the particular embodiment shown defines a through hole that penetrates ring shaped member 110. As shown in FIG. 3, in one embodiment, orifice 145 includes recessed chamfers 146 and 147 that assist in installing and securing a replaceable thread locking element 150 within cutout 140, as described below.

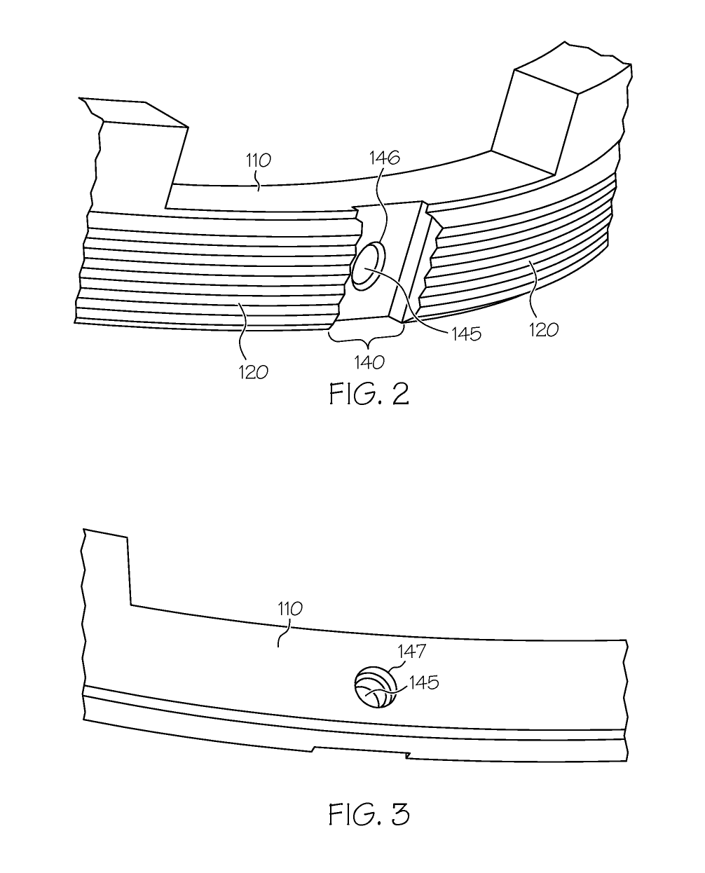

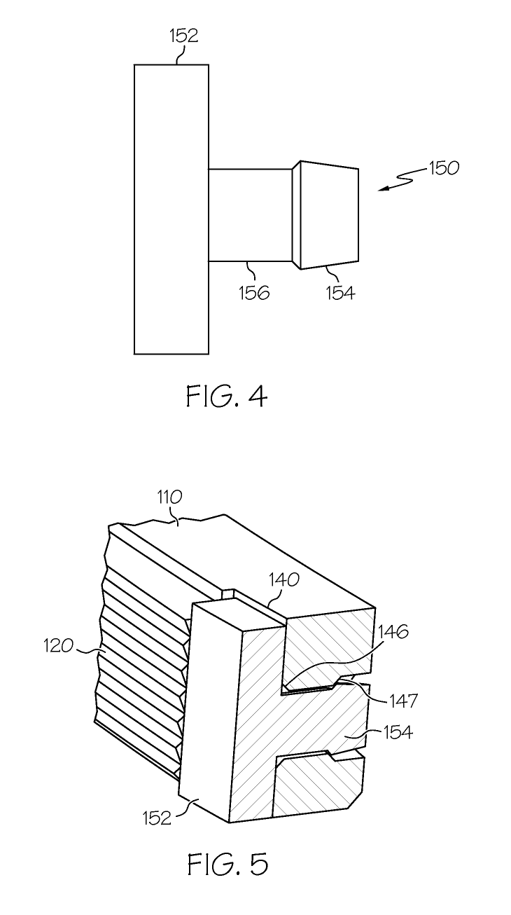

FIG. 4 is a diagram illustrating a replaceable thread locking element 150 of one embodiment of the present invention. In one embodiment, replaceable thread locking element 150 is comprised of a synthetic material such as, but not limited to, nylon. In the embodiment shown in FIG. 4, replaceable thread locking element 150 includes a displacement member 152 coupled to a nipple 154 via an extending member 156. To install replaceable thread locking element 150 within ring shaped member 110, nipple 154 is inserted into orifice 145 as illustrated in the cut-away view provided by FIG. 5. In one embodiment, chamfer 146 causes nipple to deform as it is inserted through orifice 145. Once nipple 154 clears orifice 145, it resumes its original shape, applying a friction force/pressure against ring shaped member 110 to hold displacement member 152 securely within cutout 140 and approximately flush with threaded region 120 about the circumference of ring shaped member 110. Chamfer 147 similarly causes nipple to deform to aid in removal of replaceable thread locking element 150 from ring shaped member 110 without unwanted tearing of element 150.

In operation, when threaded ring fastener 100 is installed into a female threaded receiver, the replaceable thread locking element 150′s displacement member 152 displaces threads of the threaded region 120 located 180 degrees from the element 150′s location, thereby increasing thread pressure against the receiver's threads in that area of displacement. The additional thread pressure thus functions to maintain the pre-load placed on the assembled threaded faster that was applied during torqueing. As would be appreciated by one of ordinary skill the art upon reading this specification, in alternate embodiments and applications, female threading receiver is not limited to any particular device as long as it comprises threads compatible in size, gage, and shape with the threads of threaded ring fastener 100.

Subsequently, it may become necessary to remove the threaded ring fastener 100 from its threaded receiver (such as for maintenance or repair, for example). Removing the threaded ring fastener 100 may permanently deform displacement member 152 so that it may no longer be effective in again maintaining a pre-load if it were reused. Embodiments of the present invention thus provide the ability to pop out the removable thread locking element 150, thereby extending re-use of the faster 100 itself. In one embodiment, element 150 is popped out by applying pressure to a back side of nipple 154 exposed through orifice 145. A new element 150 is then pressed in place providing a new synthetic that restores the ring assembly's resistance to movement.

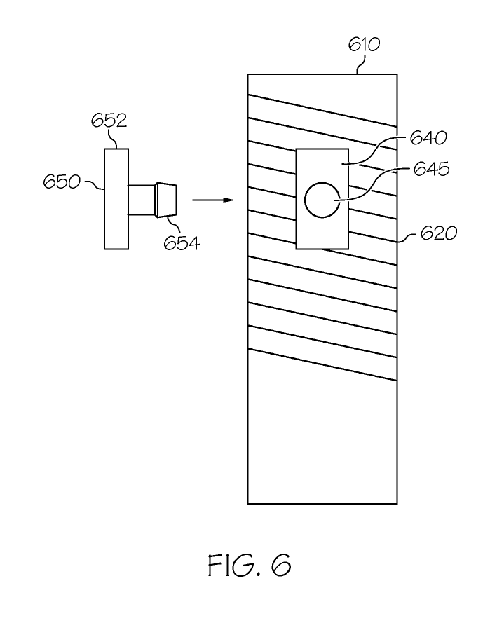

Alternate embodiments of the present invention include threaded devices beyond the threaded ring fastener described above. For example, one embodiment, illustrated in FIG. 6, comprises a male threaded fastener such as a threaded bolt 610 having a replaceable thread locking element 650. In such an embodiment, bolt 610 would comprise a threaded region 620 about its outer circumference having a cutout 640 that cuts across threaded region 620. In one embodiment, cutout 640 includes an orifice 645, through which a nipple 654 of element 650 is inserted to hold a displacement member 652 of element 650 securely within cutout 640 and approximately flush with threaded region 620, similar to as described above.

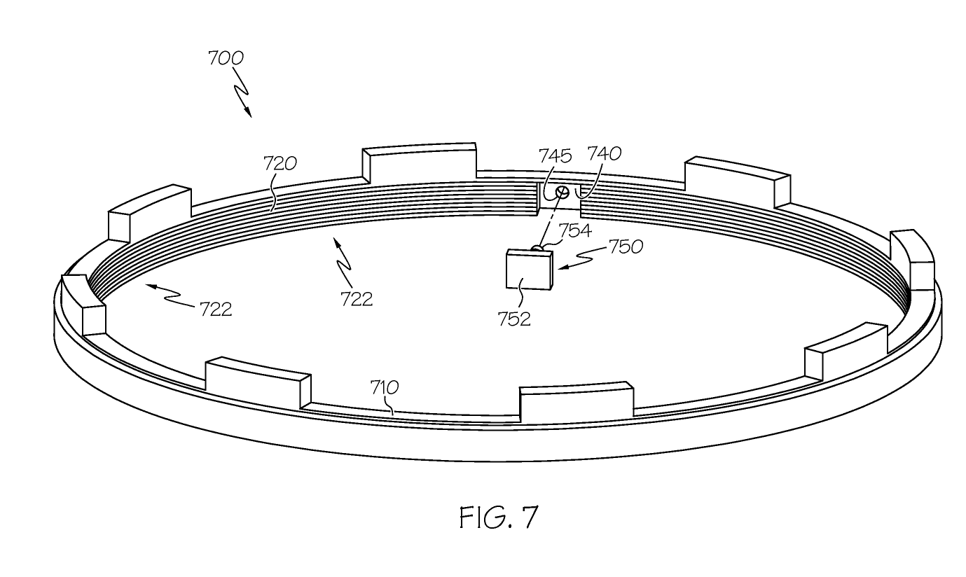

Further, in another alternate embodiment, a replaceable thread locking element is provided for female threads of a threaded fastener, such as, but not limited to a threaded nut. For example, one embodiment, illustrated in FIG. 7, comprises a threaded fastener 700 having a replaceable thread locking element 750. Threaded fastener 700 comprises a ring shaped member 710 having a threaded region 720 about its inner circumference 722. In such an embodiment, threaded region 720 includes a cutout 740 that cuts across threaded region 720. In one embodiment, cutout 740 includes an orifice 745, through which a nipple 754 of element 750 is inserted to hold a displacement member 752 of element 750 securely within cutout 740 and approximately flush with threaded region 720, similar to as described above. In operation, when threaded fastener 700 receives a threaded male fastener, the replaceable thread locking element 750′s displacement member 752 displaces threads located 180 degrees from the element 750′s location, thereby increasing thread pressure in that area of displacement similar to as described above. In each of these alternate embodiments, the thread locking element placed within the cutout of the devices threaded region is replaceable, allowing repeated use of the fastener itself.

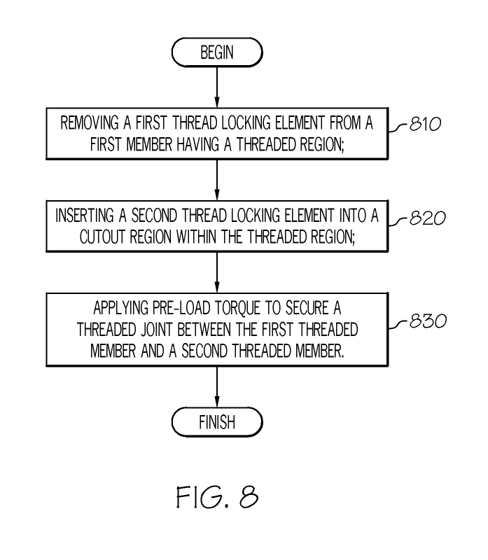

FIG. 8 is a flow chart illustrating a method of one embodiment of the present invention. The process begins at 810 with removing a first thread locking element from a first member having a threaded region. In alternate embodiments, the first member may comprise any of the threaded fastener members described above, or other threaded fastener. The method proceeds to 820 with inserting a second thread locking element into a cutout region within the threaded region. In one embodiment, the first and second thread locking elements each comprise a displacement member coupled to a nipple, such as replaceable thread locking element 150 described in FIG. 4, for example. For such an embodiment, to insert the second thread locking element the nipple is inserted into an orifice within the cutout region until the displacement member is approximately flush with the threaded region. The method then proceeds to 830 with applying a pre-load torque to secure a threaded joint between the first member and a second threaded member.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A threaded fastener device, the device comprising:
a first member having a threaded region;
a cutout within the ring shaped member that cuts across the threaded region; and
a replaceable thread locking element removeably coupled to the ring shaped member within the cutout, the replaceable thread locking element comprising a displacement member coupled to a nipple via an extending member;
wherein the nipple is inserted into and orifice within the cutout, the nipple shaped to apply a force against the first member that holds the displacement member within the cutout.

2. The device of claim 1, wherein the displacement member is secured in a position approximately flush with the threaded region.

3. The device of claim 1, wherein the orifice includes at least one recessed chamfer.

4. The device of claim 1, wherein the first member is a ring shaped member

5. The device of claim 4, wherein the orifice defines a through hole that penetrates the ring shaped member.

6. The device of claim 4, wherein the ring shaped member is a male threaded component having the threaded region about an outer circumference of the ring shaped member.

7. The device of claim 4, wherein the ring shaped member is a female threaded component having the threaded region about an inner circumference of the ring shaped member.

8. The device of claim 1, wherein the first member is a solid member having the threaded region about an outer circumference of the first member.

9. The device of claim 1, wherein the replaceable thread locking element is comprised of a synthetic material

10. The device of claim 1, wherein replaceable thread locking element comprises a nylon material.

11. The device of claim 1, the first member further comprising a tool engagement interface.

12. A threaded fastener device, the device comprising:
a first member having a threaded region that includes a replaceable thread locking element;
wherein the first member includes a cutout region within the threaded region; and
wherein the replaceable thread locking element is coupled to the first member within the cutout, wherein the replaceable thread locking element is held within the cutout by a friction fitting.

13. The device of claim 12, the replaceable thread locking element comprising a displacement member coupled to a nipple via an extending member.

14. The device of claim 13, wherein the displacement member is secured in a position approximately flush with the threaded region.

15. The device of claim 13, wherein the nipple is held by friction within a chamfered orifice within the cutout region.

16. The device of claim 12, wherein the first member is one of:
a ring shaped member with a male threaded component having the threaded region about an outer circumference of the ring shaped member;
a ring shaped member with a female threaded component having the threaded region about an inner circumference of the ring shaped member; or
a solid member having the threaded region about an outer circumference of the first member.

17. The device of claim 12, wherein the replaceable thread locking element is comprised of a nylon material.

18. The device of claim 12, the first member further comprising a tool engagement interface.

19. A method for reassembling a device, the method comprising:
removing a first thread locking element from a first member having a threaded region;
inserting a second thread locking element into a cutout region within the threaded region;
wherein the first and second thread locking elements each comprise a displacement member coupled to a nipple;
wherein the nipple is inserted into an oraphis within the cutout region until the displacement member is approximately flush with the threaded region; and
applying a pre-load torque to secure a threaded joint between the first threaded member and a second threaded member.

20. The method of claim 19, wherein the first member is one of:
a ring shaped member with a male threaded component having the threaded region about an outer circumference of the ring shaped member;
a ring shaped member with a female threaded component having the threaded region about an inner circumference of the ring shaped member; or
a solid member having the threaded region about an outer circumference of the first member.
